(19) United States
(12) Patent Application Publication
(10) Pub. No.: US 2026/0357640 A1
(43) Pub. Date: Nov. 12, 2026

(54) MODULAR WINDOW ASSEMBLY AND FRAME FOR VARIABLE WALL WIDTH APPLICATIONS AND RELATED METHODS AND SYSTEMS

(71) Applicant: Monarch Materials Group, Inc., Adel, IA (US)

(72) Inventors: Jarrad W. Lehman, Adel, IA (US); Andrew S. Kollenkark, Adel, IA (US)

(21) Appl. No.: 19/670,170

(22) Filed: May 7, 2026

Related U.S. Application Data
(60) Provisional application No. 63/801,549, filed on May 7, 2025.

(51) Int. Cl. E06B 3/26; E06B 1/28; E06B 1/56

(52) U.S. Cl. CPC E06B 3/26; E06B 1/28; E06B 1/56

(57) ABSTRACT

This disclosure is directed to a modular window assembly for embedding in cast walls, such as tilt-up concrete walls, includes a fixed frame, removable extensions, and chamfer components that interlock without custom bracing. The system accommodates varying wall widths, improves water drainage and sealing, and supports mulled window configurations using integrated anchoring and reinforcement features.

### CROSS-REFERENCES & RELATED APPLICATIONS

This application claims priority under 35 U.S.C. § 119(e) to U.S. Provisional Application No. 63/801,549, entitled “MODULAR WINDOW ASSEMBLY AND FRAME FOR VARIABLE WALL WIDTH APPLICATIONS AND RELATED METHODS AND SYSTEMS,” filed May 7, 2025, both of which are hereby incorporated by reference in its entirety for all purposes

### TECHNICAL FIELD

The disclosure relates to construction generally, and the construction of tilt-up concrete walls with windows, specifically.

### BACKGROUND

Cast concrete walls are used in the construction industry to create walls at a construction site to reduce construction costs. Certain methods presently exist to embed windows into the cast walls. Such methods are described in U.S. Pat. No. 11,834,823 and U.S. Provisional Patent Application No. 63/688,130, both of which are hereby incorporated by reference in their entirety.

The conventional methods of embedding windows into cast walls either require the window to match the width of the wall or for additional bracing to be constructed around the window to prevent the casting material, typically but not exclusively, concrete, from flowing into the window area. These two options both have considerable disadvantages. Matching the window width to the wall width either limits the variability of wall widths that can be used or requires a large variety of window widths to be ordered and tracked, adding to construction complexity and cost. Adding additional bracing around the window frame likewise requires additional labor and materials in preparing the cast wall. Additionally, the additional bracing may leave a texture, such as a wood-grain texture, in the resulting cast wall, which may be undesirable.

### BRIEF SUMMARY OF THE INVENTION

This disclosure solves the problems described above and known to those skilled in the art by providing systems, devices, and methods for embedding a window into a cast wall that allows for flexibility in casting structures into place.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1 is a perspective diagram of a prior art window assembly.

FIG. 2 is a perspective diagram of a prior art window assembly with spacer bucks.

FIG. 3 is a cross-sectional diagram of an improved window assembly, according to one implementation.

FIG. 4 is a cross-sectional diagram of a fixed frame in the improved window assembly, according to one implementation.

FIG. 5 is a cross-sectional diagram of an extension in the improved window assembly, according to one implementation.

FIG. 6 is a cross-sectional diagram of a ledge chamfer with a foot web in the improved window assembly, according to one implementation.

FIG. 7 is a cross-sectional diagram of a ledge chamfer with no foot web in the improved window assembly, according to one implementation.

FIG. 8 is a cross-sectional diagram of two fixed frames connected as would be seen in a mulled window, according to one implementation.

FIG. 9 is a cross-sectional diagram of a ledge chamfer with a foot web in the improved window assembly, according to one implementation.

FIG. 10 is a cross-sectional diagram of a ledge chamfer with no foot web in the improved window assembly, according to one implementation.

FIG. 11 is a cross-sectional diagram of a extension in the improved window assembly, according to one implementation.

FIG. 12 is a cross-sectional diagram of another extension in the improved window assembly, according to one implementation.

FIG. 13 is a cross-sectional diagram of a fixed frame in the improved window assembly, according to one implementation.

### DETAILED DESCRIPTION

This disclosure is directed to various implementations of a system, and related devices and methods, for embedding a window into a cast wall, such as a tilt-up concrete wall. The various implementations of the system may allow for the embedding of windows in walls of varying width without the need for custom bracing.

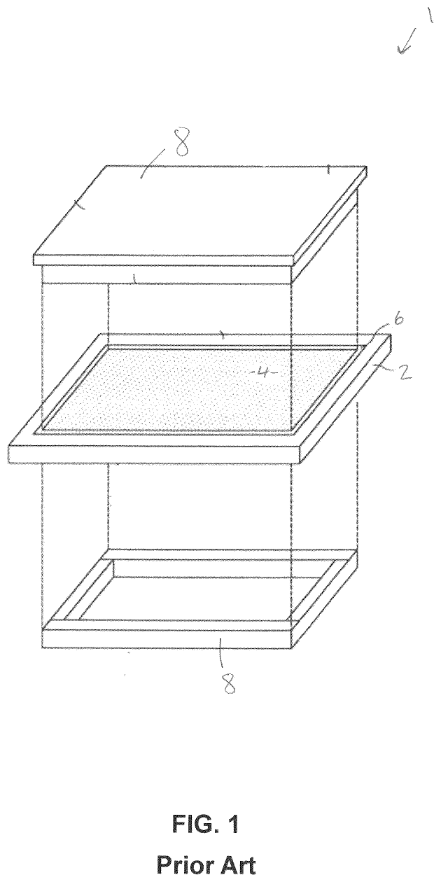

FIG. 1 shows a prior art window assembly 1 that may have a frame 2 holding a glass portion 4, which may be secured to the frame 2 by a sash 6. As would be understood, the prior art window assembly 1 may be configured to be placed into the casting area of a cast wall, such as a concrete wall, prior to the introduction of the casting material, such that the window assembly is enveloped in the cast wall during and after casting. The glass portion 4 may be made of various materials including but not limited to glass of all varieties like tempered glass, laminated glass, borosilicate glass, and the like, or various plastics, such as polycarbonate, acrylic, or the like.

The prior art window assembly 1 may also contain bracing 8 that may prevent the incursion of the casting material into areas where it is not desired, such as in front of the glazing 4.

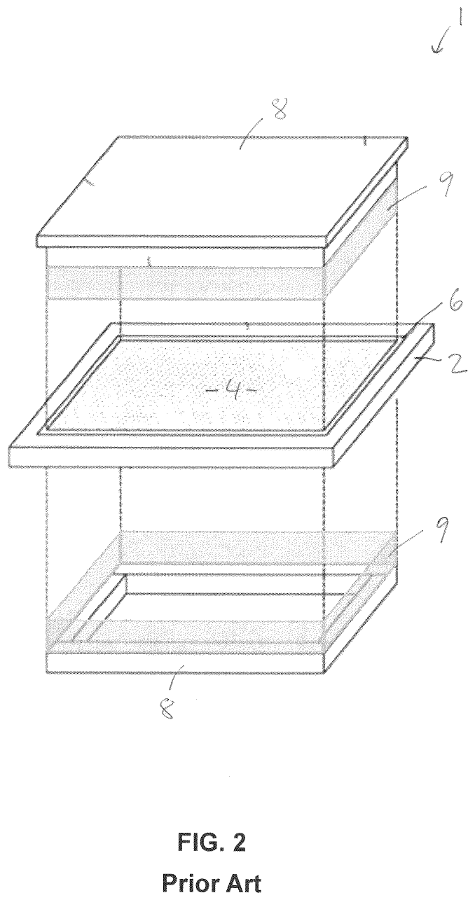

Turning now to FIG. 2, in certain instances, those casting window assemblies may desire to position a prior art window assembly 1 in a cast wall at a desired depth, where the depth of the frame 2 is smaller than the depth of the wall. Practitioners of traditional techniques would then employ spacer bucks 9, which may be extensions of the bracing 8 to increase the effective depth of the prior art window assembly 1 during casting.

The spacer bucks 9 are typically wood forms that are cut to size for each installation or work site. As discussed above, the use of the spacer bucks 9 comes with several disadvantages. For instance, if the spacer bucks 9 are not reused, they need to be cut to size for each job, which can be time consuming and labor intensive. If the spacer bucks 9 are reused, they can only be used on windows of the same size, and they must be hauled to each job site. As the spacer bucks 9 are often quite heavy, this is also costly and time consuming, in addition to being limiting to their applicability.

In order to solve these problems, this disclosure presents an improved window assembly 10 that uses a modular frame 12 that eliminates the need for spacer bucks 9, as well as providing various other benefits and features. While a variety of shapes and geometries are possible, a common implementation of the improved window assembly 10 involves the formation of four modular frames 12 into a rectangular frame. Other implementations involve a number of modular frames 12 forming a perimeter with a glass portion 4 bound and supported by the modular frames 12, as would be understood by those skilled in the art.

As used herein, “web” refers to a thin wall of material that may be shaped in a manner that forms a body. In various implementations, the webs may be extruded to form a lightweight, elongate structure.

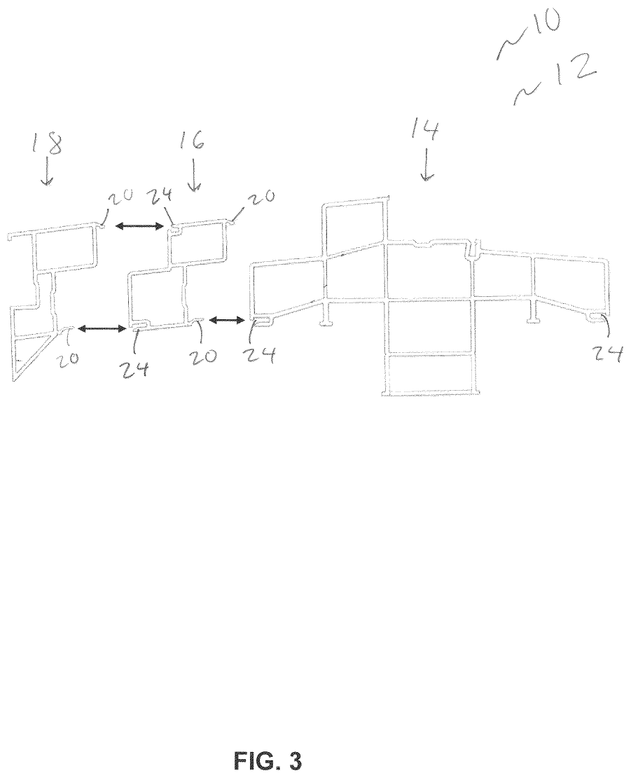

FIG. 3 shows a cross-section of one implementation of the modular frame 12, where the modular frame 12 has a fixed frame 14, one or more extensions 16, and a ledge chamfer 18. The fixed frame 14, extensions 16, and ledge chamfer 18 may interlock through one or more tabs 20 and one or more linking slots 24, as indicated by the arrows shown in FIG. 3. In certain implementations, the extensions 16 and ledge chamfer 18 may be removed after the casting process is complete. In such implementations, the fixed frame 14 may have a single linking slot 24 to allow for the extensions 16 and ledge chamfer to be removed more easily.

The tabs 20 and linking slots 24 may snap together securely. The secure fit of the tabs 20 and linking slots 24 may increase the concrete pressure that the improved window assembly 10 may be able to withstand, and the secure fit may improve the ability of the improved window assembly 10 to prevent water incursion.

The modular frame 12 may be made of a variety of materials, such as but not limited to polymers, wood, metal, or the like. In certain implementations, the modular frame 12 may be made of vinyl. In implementations with vinyl construction, there may be no need for a thermal break, as the vinyl modular frame 12 has sufficient physical properties to act as a thermal break. In further implementations, the modular frame 12 may be made of regrind vinyl, which may provide a reduction in material cost compared to other materials, such as but not limited to virgin vinyl. In still further implementations, disposable sections of the modular frame 12, such as but not limited to the extensions 16 and ledge chamfer 18, may be regrind vinyl, where the permanent sections of the modular frame 12, such as but not limited to the fixed frame 14, may be a different material, such as virgin vinyl.

In various implementations, the number of extensions 16 may be changed as desired to allow the improved window assembly 10 to be used in walls of varying width without the need for spacer bucks 9, as will be discussed in detail below.

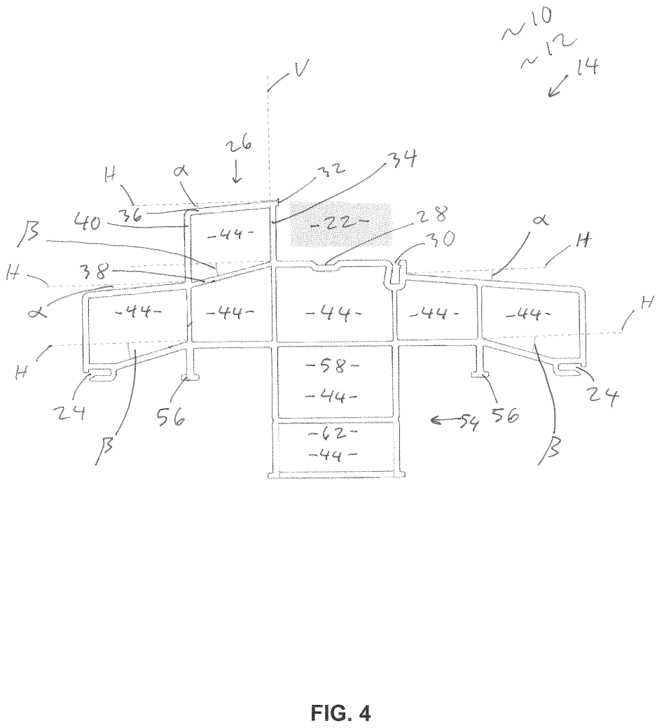

Turning to FIG. 4, the fixed frame 14 may have a pocket 22 that may be used to secure the glass portion 4. In certain implementations, the glass portion 4 may be an insulated glass unit. The glass portion 4 in the pocket 22 may be held against the glazing tower 26. Once in place, the glass portion 4 may be secured in place by a sash 6, that may be inserted in a sash slot 30. The pocket 22 may vary in size to accommodate glass portions 4 of various widths, such as between about 0.5 inch to about 2 inches. In certain implementations, the pocket 22 may be sized to accommodate glass portions 4 with the width in the range of about 1 inch to about 1.31 inches. In still further implementations, the pocket 22 may be sized to accommodate glass portions 4 with a width smaller than 0.5 inch or larger than 2 inches.

The fixed frame 14 may have a sealant recess 28, which may be a concave portion of a web that would abut the glass portion 4. The sealant recess 28 may allow for a sufficient amount of sealant material to remain between the fixed frame 14 and glass portion 4 to ensure a reliable seal. As would be understood, if the fixed frame 14 had only a flat side, which may be pressed against a complimentary flat side, substantially all of the sealant may be pressed from between the components, allowing for leaks.

The glazing tower 26, in certain implementations, may have a ledge 32 that may be a protuberance extending toward the pocket 22 from the sealing web 34 of the glazing tower 26. The ledge 32 may ensure that the glass portion 4 cannot press flat against the glazing tower 26, where a large portion of sealant between the glass portion 4 and glazing tower 26 may be pressed out from between the glass portion 4 and glazing tower 26. The ledge 32 may ensure a sufficient amount of sealant remains between the glazing tower 26 and glass portion 4 to ensure a watertight and airtight seal. The glazing tower 26 may also be of sufficient width and rigidity to add strength to the glass portion 4.

The glazing tower 26 may have an upper web 36, that may face upwards when the fixed frame 14 is installed at the bottom of a window. The upper web 36 may be sloped away from the pocket 22 and glass portion 4 as to allow water to flow away from the pocket 22 and glass portion 4. As would be understood, facilitating the flow of water away from the pocket 22 and glass portion 4 may reduce or eliminate the risk of the water pooling against the glass portion 4, where the water may penetrate a seal in the modular frame 12. In various implementations, the upper web 36 may be sloped at a first angle α relative to the horizontal plane H, which may be about perpendicular to a vertical plane V, which may be about parallel with the glass portion 4. In various implementations, the angle α of the upper web 36 may be any value between about 0° and about 90°. In certain implementations, the angle α may be about 5°, about 10°, about 15°, about 20°, about 25°, about 30°, about 35°, about 40°, about 45°, about 50°, about 55°, about 60°, about 65°, about 70°, about 75°, about 80°, or about 85°.

The glazing tower 26 may also have a lower web 38 that may be sloped away from the pocket 22 such that if water enters the void 44 of the glazing tower 26, which may be formed by the sealing web 34, upper web 36, lower web 38, and outer web 40, the water may flow toward a weep hole (not shown) that may be drilled into the outer web 40 so the water may exit the fixed frame 14. In various implementations, the lower web 38 may be sloped at a second angle β relative to the horizontal plane H. In various implementations, the angle β of the lower web 38 may be any value between about 0° and about 90°. In certain implementations, the angle β may be about 5°, about 10°, about 15°, about 20°, about 25°, about 30°, about 35°, about 40°, about 45°, about 50°, about 55°, about 60°, about 65°, about 70°, about 75°, about 80°, or about 85°.

Still in FIG. 4, in various implementations, the fixed frame 14 may have an interior web 42 that may be sloped in toward the interior side 46 of the fixed frame 14 to allow for rainwater to flow off of the fixed frame 14 and prevent pooling. In some implementations, the fixed frame 14 may have an exterior web 48 that may be sloped toward the exterior side 50 to allow for water, such as rainwater, to flow off of the fixed frame 14 and prevent pooling. In various implementations, the slope of the interior web 42 and exterior web 48 may be about the angle α from the horizontal plane H (discussed above), although other angles are of course possible.

In some implementations, the fixed frame 14 may have one or more sloped bottoms 52 that may be sloped toward the interior side 46 or exterior side 50 such that water that may enter the voids 44 of the fixed frame 14 may flow toward a weep hole (not shown) that may be drilled into the interior web 42 so the water may exit the fixed frame 14.

In various implementations, the fixed frame 14 may have an anchor hat 54 that may extend out from the fixed frame 14 to ensure the fixed frame 14 is secure in the wall in which the fixed frame 14 is cast. The anchor hat 54 may have one or more retention flanges 60 that extend from the anchor hat 54 to ensure the fixed frame 14 is firmly secured into the cast wall. Additionally, the anchor hat 54 may serve as a position for users of the improved window assembly 10 to grip the fixed frame 14 and improved window assembly 10, generally.

The fixed frame 14 may also have several anchor legs 56 that may protrude in generally the same direction as the anchor hat 54. The anchor legs 56 may flair at their tips in order to increase the strength of the holding power of the concrete on the fixed frame 14.

The anchor hat 54, in various implementations, may also be of sufficient height to ensure components attached to the fixed frame 14 may not have to support the weight of the improved window assembly 10 when the improved window assembly 10 is face down, as might be seen during shipping. As shown in FIG. 3, the anchor hat 54 may accomplish this by extending below the lowest point of the ledge chamfer 18.

The anchor hat 54 may contain two voids 44 separated by a web, a top hollow 58 and a bottom hollow 62. The top hollow 58 may be of sufficient size to allow a reinforcing beam to be inserted, which may add additional strength and rigidity to large windows or mulled windows, which will be discussed in detail below. The top hollow 58 may be a variety of sizes to accommodate the reinforcing beam, such as but not limited to about 0.75 inches to about 1.25 inches.

The fixed frame 14 may be a variety of widths. The width of the fixed frame 14 in the improved window assembly 10 may be independent of the width of the cast wall in which it may be installed. In certain implementations, the fixed frame 14 may be about 5.75 inches in width, which may allow the improved window assembly 10, including ledge chamfers, to be used on the smallest cast walls typically used.

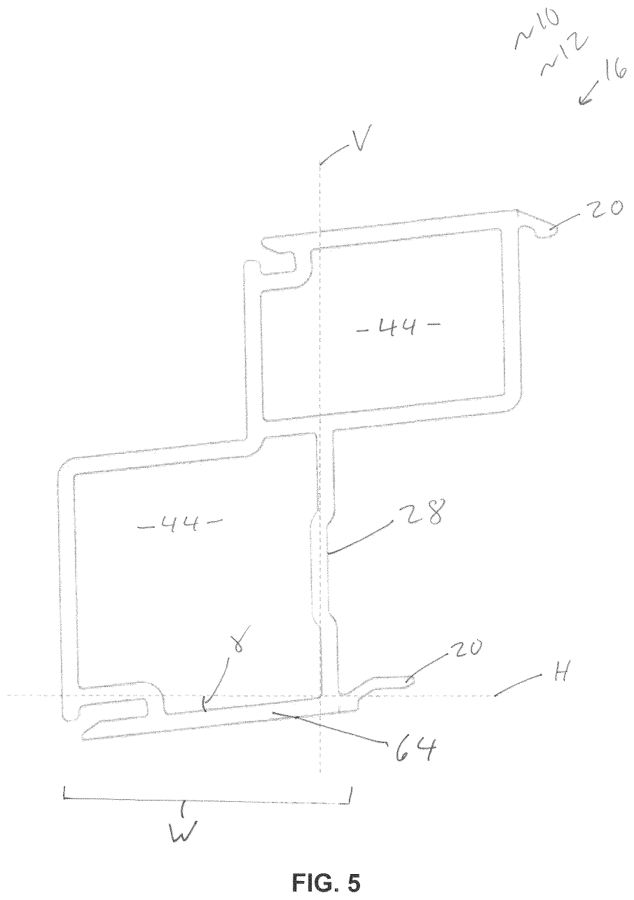

Turning now to FIG. 5, the extension 16 may be of similar construction to the fixed frame 14, optionally being made of various webs and voids 44 to create a lightweight form that may be extruded. The extension 16 may have one or more tabs 20 configured to attach to either the fixed frame 14 or to another extension 16. To allow more than one extension 16 to be secured together, each extension 16 may also have one or more linking slots 24 configured to correspond to the tabs 20. By linking the extensions 16 together, a user of the improved window assembly 10 may quickly and easily adapt the improved window assembly 10 to a wall with a different width than the fixed frame 14. Alternative implementations may use no extensions 16 at all and may instead link the ledge chamfer 18 directly to the fixed frame 14, as will be discussed below.

The extensions 16, in various implementations, may have a functional width W that represents the width added to the improved window assembly 10 when each extension 16 is used. The functional width W of the extensions 16 may be of any measure that may be desirable or useful. Certain implementations of the extension 16 may have a functional width W of a quarter inch. Other implementations of the extension 16 may have a functional width W of measures such as but not limited to a half inch, three-quarters of an inch, one inch, two inches, or three inches. Further implementations may have functional widths W longer than three inches. Still further implementations may have functional widths W smaller than a quarter inch. As would be understood, extensions 16 of varying functional widths W may be combined to achieve other total widths of the window assembly, reducing the variety of extensions 16 needed and eliminating the need for custom-cut spacer bucks 9.

The extensions 16 may have a bottom web 64 that is at an angle γ from the horizontal plane H. In various implementations, the bottom web 64 may be in contact with the casting material during the casting process. Due to this, the casting material may be cast at a slope with the angle γ and may retain that slope after casting and the removal of the extensions 16. The slope of the resulting cast material may aid in the drainage of either rainwater or interior water, depending on whether the extensions 16 were used on the interior or exterior sides of the improved window assembly 10. In various implementations, the angle γ of the bottom web 64 may be any value between about 0° and about 90°. In certain implementations, the angle γ may be about 5°, about 10°, about 15°, about 20°, about 25°, about 30°, about 35°, about 40°, about 45°, about 50°, about 55°, about 60°, about 65°, about 70°, about 75°, about 80°, or about 85°.

In some implementations, the extensions 16 may have a sealant recess 28, which may be a concave portion of a web that would abut the fixed frame 14 or another extension 16. The sealant recess 28 may allow for a sufficient amount of sealant material to remain between the extension 16 and the abutting extension 16 or fixed frame 14 to ensure a reliable seal. As would be understood, if the extension 16 had only a flat side, which may be pressed against a complimentary flat side, substantially all of the sealant may be pressed from between the components, allowing for leaks. The sealant recess 28 may similarly accommodate glue, tape, gaskets, or similar components that may seal or secure the joint between components.

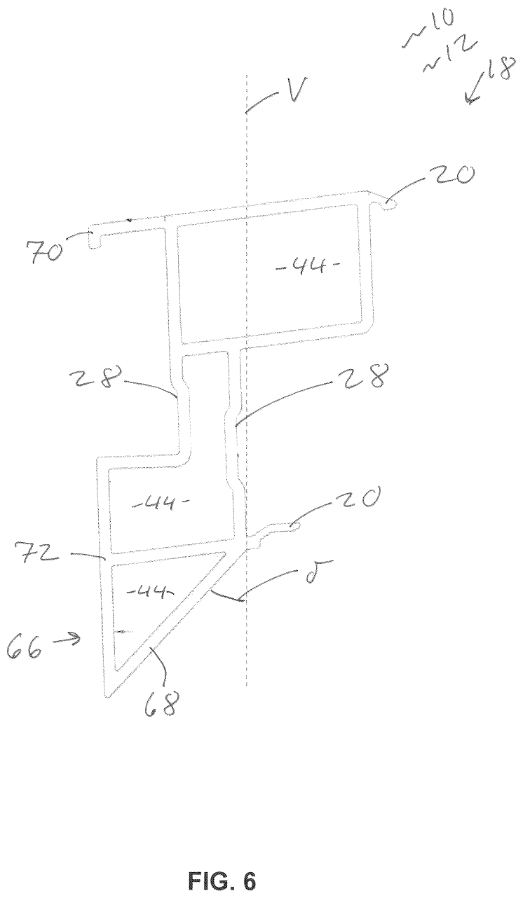

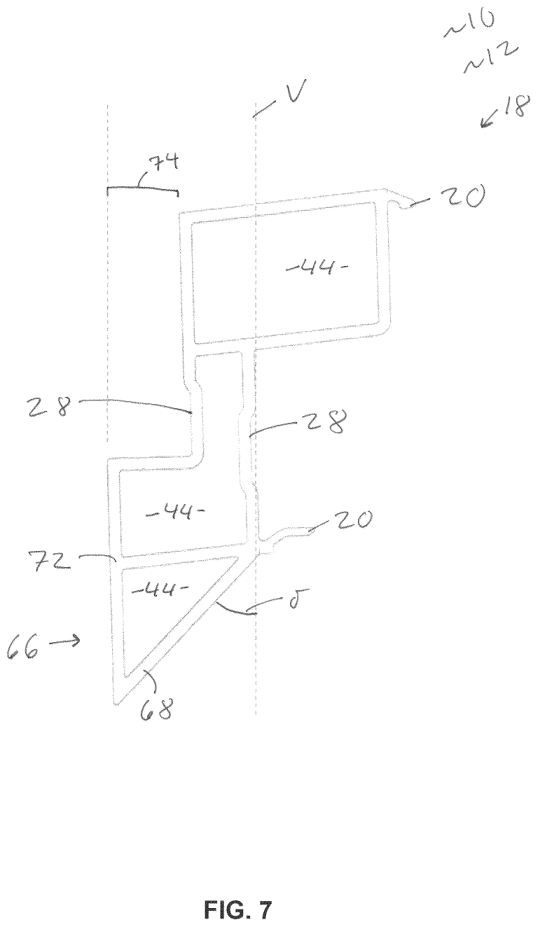

Turning now to FIGS. 6 and 7, the ledge chamfer 18 may be of similar construction to the fixed frame 14, optionally being made of various webs and voids 44 to create a lightweight form that may be extruded. The ledge chamfer 18 may have one or more tabs 20 configured to attach to either the fixed frame 14 or an extension 16.

The ledge chamfer 18 may have a chamfer segment 66 that may extend past the plane formed by the sloped bottoms 52 in order to form a chamfer as the cast wall is cast. The ledge chamfer 18 may have a chamfer web 68 that may form the surface of the cast chamfer in the wall. The chamfer web 68 may be at an angle δ from the vertical plane V. In various implementations, the angle δ of the chamfer web 68 may be any value between about 0° and about 90°. In certain implementations, the angle δ may be about 5°, about 10°, about 15°, about 20°, about 25°, about 30°, about 35°, about 40°, about 45°, about 50°, about 55°, about 60°, about 65°, about 70°, about 75°, about 80°, or about 85°.

FIG. 6 shows an implementation of the ledge chamfer 18 that has a foot web 70. The foot web 70 may provide additional support for the ledge chamfer 18 and the improved window assembly 10. In various implementations, the foot web 70 may be about in line with the outer edge 72 of the ledge chamfer 18. In implementations where the improved window assembly 10 is cast into a wall while in a horizontal orientation, the foot web 70 and outer edge 72 may be in contact with the ground. Because of the presence of the foot web 70, the ledge chamfer 18 may be stable and supported at both ends.

FIG. 7 shows an implementation of the ledge chamfer 18 with no foot web 70 but instead may have a cutout 74. The cutout 74 may be an offset in the ledge chamfer 18 relative to the outer edge 72. In certain implementations, the cutout 74 may allow for a sheet of material to be placed over the improved window assembly 10, where the sheet would then be held in place by the ledge chamfers 18 surrounding the improved window assembly 10. In implementations in which the improved window assembly 10 is cast into a wall while in a horizontal orientation, the sheet of material that may be secured in the cutouts 74 of the ledge chamfers 18 in use may allow users of the improved window assembly 10 to walk on top of the improved window assembly 10 and to prevent the incursion of casting material during the casting process. In certain implementations, the cutouts 74 may be large enough to accommodate a ⅜ inch thick sheet of material, although other sizes/depths are of course possible. The sheet of materials may be a polymer material, wood, metal, or other material that may provide a rigid and protective surface.

The ledge chamfer 18 may have a sealant recess 28 which may be a concave portion of a web that would abut the sheet of material or similar component. The sealant recess 28 may allow for a sufficient amount of sealant material to remain between the ledge chamfer 18 and sheet of material to ensure a reliable seal. As would be understood, if the ledge chamfer 18 had only a flat side, which may be pressed against a complimentary flat side, substantially all of the sealant may be pressed from between the components, allowing for leaks.

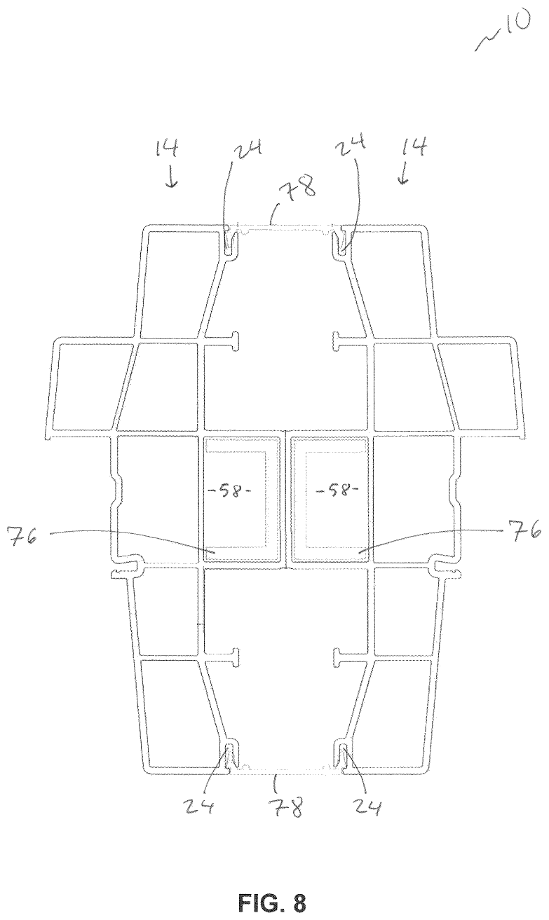

Turning now to FIG. 8, in some implementations, the improved window assembly 10 allows for modular frames 12 and/or fixed frames 14 to be secured together to create a mulled window. In such implementations, the anchor hats 54 of two or more fixed frames 14 may be shortened by removing the webs around the bottom hollows 62. The fixed frames 14 may then be placed together, with the shortened anchor hats 54 touching or nearly touching. At some point during this process, reinforcing beams 76 may be inserted into the top hollow 58 of each fixed frame 14. The reinforcing beams 76 may be a variety of shapes and may be made from a variety of materials. The reinforcing beams 76 may be but are not limited to square/rectangular tubing, solid bar, angle sections, U-channel sections, and the like. The reinforcing beams 76 may be made of materials including but not limited to wood, polymer, steel, iron, aluminum, or a combination of such materials or similar materials.

Once the fixed frames 14 are placed together, they may be secured to one another by mullion strips 78. In various implementations, the mullion strips 78 may snap into the linking slots 24 of the two fixed frames 14 and secure the fixed frames 14 together.

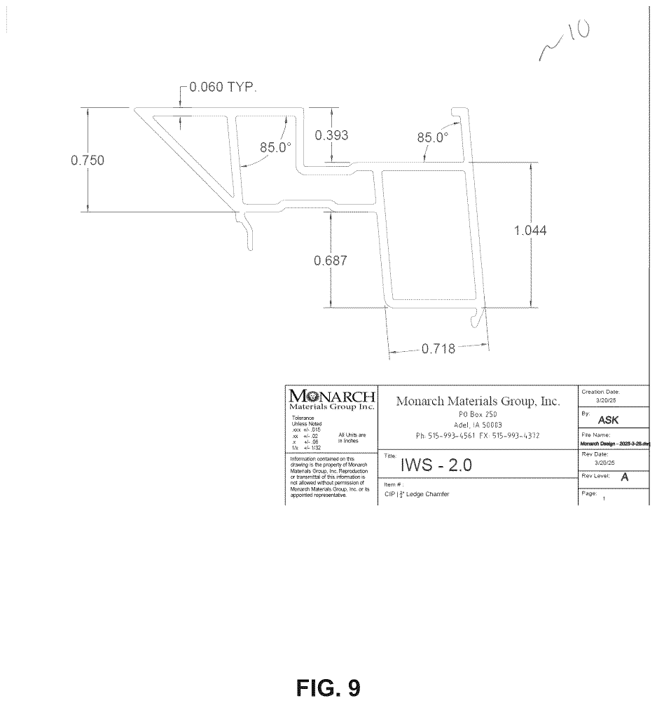

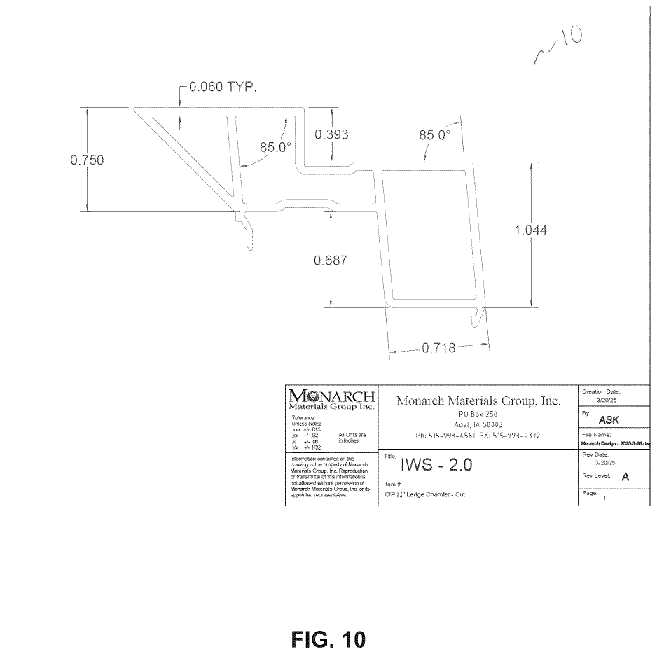

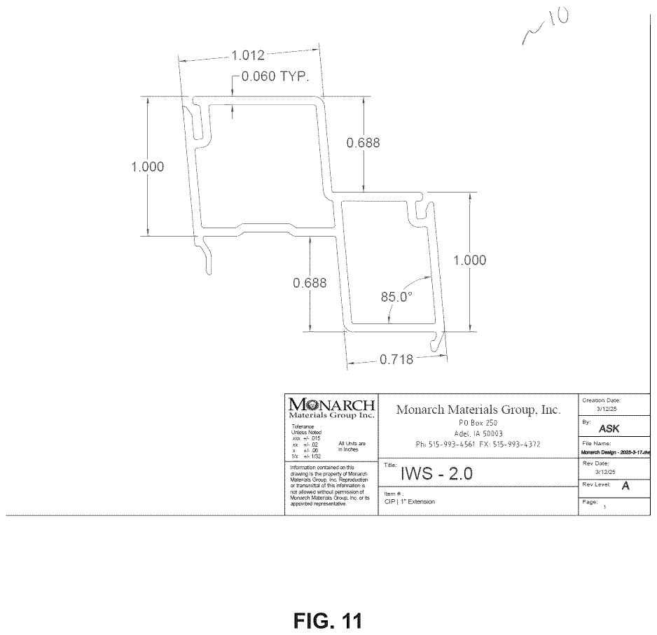

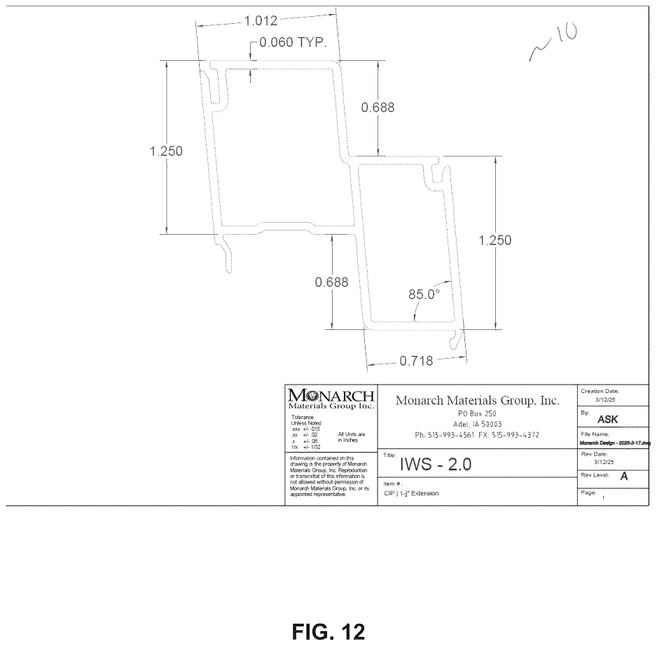

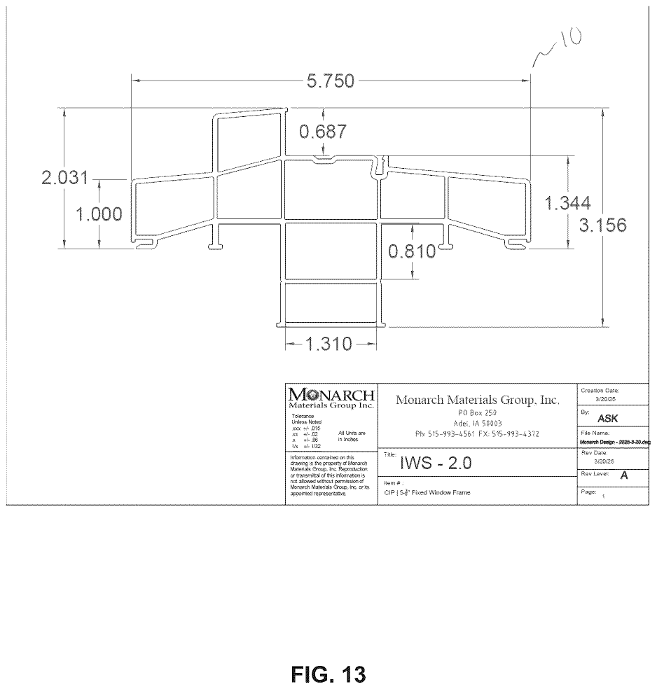

FIGS. 9-13 show various implementations of the various components of the improved window assembly 10.

Although the disclosure has been described with reference to preferred embodiments, persons skilled in the art will recognize that changes may be made in form and detail without departing from the spirit and scope of the disclosed apparatus, systems and methods.

What is claimed is:

1. An improved window assembly comprising:
a fixed frame configured to receive a glass portion;
and
a ledge chamfer configured to be couplable to the fixed frame.

2. The improved window assembly of claim 1, further comprising a plurality of extensions configured to be couplable to the fixed frame,
wherein the ledge chamfer is configured to be couplable to the plurality of extensions or to the fixed frame.

3. The improved window assembly of claim 2, wherein the fixed frame, the plurality of extensions, and the ledge chamfer are configured to interlock through one or more tabs and one or more linking slots

4. The improved window assembly of claim 1, wherein the fixed frame comprises a glazing tower having a sealing web, an upper web, a lower web, and an outer web forming a void, and a ledge protruding from the sealing web toward a pocket configured to receive the glass portion, the ledge configured to maintain a spacing between the glass portion and the glazing tower to retain sealant therebetween.

5. The improved window assembly of claim 4, wherein the upper web is sloped away from the pocket at a first angle relative to a horizontal plane to direct water away from the glass portion.

6. The improved window assembly of claim 1, wherein the fixed frame comprises an anchor hat extending outward from the fixed frame, the anchor hat having one or more retention flanges and defining a top hollow configured to receive a reinforcing beam.

7. The improved window assembly of claim 6, wherein the anchor hat extends below a lowest point of the ledge chamfer such that the ledge chamfer is not required to support a weight of the improved window assembly when the improved window assembly is oriented face down.

8. The improved window assembly of claim 2, wherein each of the plurality of extensions has a functional width, and wherein extensions of differing functional widths are combinable to adapt the improved window assembly to cast walls of varying widths without spacer bucks.

9. The improved window assembly of claim 2, wherein at least one of the fixed frame, the plurality of extensions, or the ledge chamfer comprises a sealant recess formed as a concave portion of a web, the sealant recess configured to retain sealant material between abutting components.

10. The improved window assembly of claim 1, wherein the ledge chamfer comprises a chamfer segment extending past a plane formed by one or more sloped bottoms of the fixed frame, and a chamfer web disposed at an angle from a vertical plane.

11. The improved window assembly of claim 10, wherein the ledge chamfer further comprises a foot web configured to contact a ground surface to provide support when the improved window assembly is in a horizontal orientation during a casting process.

12. The improved window assembly of claim 10, wherein the ledge chamfer further comprises a cutout configured to receive a sheet of material over the improved window assembly to prevent incursion of casting material during a casting process.

13. A method of embedding a window in a cast wall of variable width, the method comprising:
providing a fixed frame configured to receive a glass portion, the fixed frame having one or more linking slots;
coupling a ledge chamfer to the fixed frame;
positioning an assembly of the fixed frame and the ledge chamfer in a casting area; and
introducing a casting material into the casting area to embed the window in the cast wall.

14. The method of claim 13, further comprising coupling one or more extensions to the fixed frame via one or more tabs engaging the one or more linking slots, a number of extensions selected based on a desired total width corresponding to a width of the cast wall,
wherein the ledge chamfer may be coupled to an outermost member of the plurality of extensions, and
wherein the plurality of extensions may be positioned with the assembly of the fixed frame and ledge chamfer in the casting area.

15. The method of claim 14, further comprising removing the one or more extensions and the ledge chamfer from the fixed frame after the casting material has set.

16. The method of claim 13, wherein providing the fixed frame comprises providing the fixed frame with an anchor hat having one or more retention flanges configured to secure the fixed frame in the cast wall.

17. The method of claim 14, wherein coupling the one or more extensions comprises selecting extensions having differing functional widths and combining the selected extensions to achieve the desired total width without spacer bucks.

18. A modular frame system for embedding a window in a cast wall of variable width, the system comprising:
a fixed frame having a pocket configured to receive a glass portion and an anchor hat configured to secure the fixed frame in the cast wall, the anchor hat defining a top hollow;
a plurality of extensions, each extension having at least one tab and at least one linking slot, the extensions being selectively couplable to the fixed frame and to one another via the tabs and linking slots to adjust a total width of the modular frame system to correspond to the width of the cast wall; and
a ledge chamfer having a chamfer segment and being couplable to the fixed frame or to one of the plurality of extensions via a tab and linking slot connection.

19. The modular frame system of claim 18, further comprising a reinforcing beam insertable into the top hollow of the anchor hat, and a mullion strip configured to snap into linking slots of two adjacent fixed frames to secure the two adjacent fixed frames together in a mulled window configuration.

20. The modular frame system of claim 18, wherein the fixed frame further comprises a glazing tower having an upper web sloped at a first angle relative to a horizontal plane to direct water away from the pocket, and a lower web sloped at a second angle relative to the horizontal plane to direct water within the glazing tower toward a weep hole.
